(19) United States
(12) Patent Application Publication
(10) Pub. No.: US 2009/0153091 A1
(43) Pub. Date: Jun. 18, 2009

(54) IMAGE FORMATION APPARATUS

(75) Inventors: Takahiro Tsujimoto, Toyokawa-shi (JP); Takashi Honda, Toyokawa-shi (JP); Shiro Umeda, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/333,000

(22) Filed: Dec. 11, 2008

(30) Foreign Application Priority Data
Dec. 14, 2007 (JP) 2007-323127

(51) Int. Cl. G05B 6/02

(52) U.S. Cl. 318/561

(57) ABSTRACT

An error detector determines whether or not there is a frequency error. In a case where it is determined that there is the frequency error, the error detector further determines whether or not the frequency error stays within a targeted error range. In a case where it is determined that the frequency error stays within the targeted error range, a proportional gain is decreased. In a case where it is determined that the frequency error fails to stay within the targeted error range, the proportional gain is increased. Then, a frequency proportional-integral-derivative operation processing is executed based on a set gain.

This application is based on Japanese Patent Application No. 2007-323127 filed with the Japan Patent Office on Dec. 14, 2007, the entire content of which is hereby incorporated by reference.

### BACKGROUND OF THE INVENTION

1. Field of the Invention

The present invention relates to an image formation apparatus, particularly to an image formation apparatus in which a direct-current (DC) brushless motor is used in a drive mechanism.

2. Description of the Background Art

In some of image formation apparatuses such as a copying machine, a printer, an MFP (Multi Function Peripheral) in which functions of the copying machine and the printer are combined, and the like, the DC brushless motor, an alternating-current (AC) motor or a stepping motor is selectively used in a drive mechanism depending on different objects.

In a case where the DC brushless motor is used in the drive mechanism, a feedback gain, a phase compensation constant, and the like, may be set hardware-wise in a motor control substrate of the DC brushless motor in some cases.

FIG. 9 illustrates a constitution of a conventional brushless motor.

Referring to FIG. 9, a control circuit 1005 in a control substrate 1000 outputs a control signal (clock signal), which is an instruction signal, in order to set a targeted speed (number of rotations). In response to input of the control signal (clock signal), a motor driver circuit 1020 in a motor control substrate 1010 controls current supplied to a DC brushless (DCBL) motor unit 1015 so that the targeted speed is obtained. Then, a feedback control is executed in motor control substrate 1010 so that the DC brushless motor is rotated at a constant speed.

FIG. 10 illustrates a constitution inside the motor control substrate.

Referring to FIG. 10, DC brushless motor unit 1015 and motor driver circuit 1020 are provided in the motor control substrate. The motor control substrate is designed such that a resistance element and a capacitance element can be externally connected to motor driver circuit 1020.

DC brushless motor unit 1015 includes a motor 1016 and a frequency generator (FG sensor) 1017 which detects a rotation speed (number of rotations) of motor 1016. FG sensor 1017 generates a FG signal (FG pulse), which is a rotation signal, based on the variation of magnetic flux in accordance with the rotation speed (number of rotations) of a rotor of motor 1016.

frequency of FG pulse=number of rotations of motor (rpm)÷60×number of FG pulses

The number of FG pulses is the number of the pulses outputted from a so-called FG pattern by each rotation of the motor.

Motor driver circuit 1020 includes a speed detector 1025 which detects the FG pulse from FG sensor 1017 which is the rotation signal of motor 1016, a speed deviation signal generator 1022 which generates a frequency deviation signal showing a deviation between the frequency of the FG pulse and the control signal (clock signal) inputted from the control circuit corresponding to the targeted speed in response to a result of the detection by speed detector 1025, a phase deviation signal generator 1024 which generates a phase deviation signal showing a deviation between a phase of the FG pulse and a phase of the control signal (clock signal) inputted from the control circuit in response to the detection result by the speed detector 1025, an operational amplifier AMP, a PWM (Pulse Width Modulation) chopper 1026 which generates a PWM signal for setting an amount of current supplied to a current supply unit 1028 in response to an output signal from the operational amplifier AMP, and current supply unit 1028 which adjusts the current supplied to motor 1016 in accordance with the PWM signal generated by the PWM chopper 1026.

The operational amplifier AMP, to which the resistance element and the capacitance element are externally connected, constitutes a proportional-integral circuit. More specifically, resistance elements R1 and R2 are respectively provided in parallel between an input node of the operational amplifier, and speed deviation signal generator 1022 and phase deviation generator 1024. Further, a resistance element R3 and a capacitance element C1 are connected to each other in series and further connected to between the input node and an output node of the operational amplifier. A capacitance element C2 is connected in parallel to between the input node and the output node. Another input terminal of the operational amplifier is supplied with a reference voltage Vref.

According to the constitution, a proportional and integral circuit 1030 is formed, and generally called PI control (Proportional and Integral), which is one of feedback control methods, is executed.

More specifically, the speed deviation signal and the phase deviation signal are added, and the deviation is thereby amplified. Then, a duty ratio of the PWM signal of PWM chopper 1026 is adjusted, and the volume of current supplied to motor 1016 is controlled.

In the conventional DC brushless motor, parts were replaced in accordance with, for example, the number of rotations, and a gain of the proportional and integral circuit was then tuned. Though not shown in the drawing, for example, a circuit for changing resistance values of the resistance element and the capacitance element externally provided, which constitute proportional and integral circuit 1030, or the like, was provided so that the gain tuning was implemented.

FIG. 11 illustrates the gain tuning in accordance with the number of rotations.

As shown in FIG. 11, a method conventionally adopted was to change gain H and gain L in relation to a gain in a proportional term P (hereinafter, may be referred to as P gain) of the PI control, which is the proportional and integral control, in accordance with the number of rotations. In the present example, the gain was changed depending whether the number of rotations was, for example, at least or below 1,500 rpm.

In a case where the gain is thus tuned in two stages, however, the gain is excessively large in a low-rotation region where the gain is changed, which generates such problems that an image quality is deteriorated and a noise when the image formation apparatus is driven is increased.

Japanese Laid-Open Patent Publication No. 2002-345278 discloses a control method wherein a drive table suitable for an intended usage is selected, and parameters of the selected drive table are used to execute proportional-integral-derivative control, in other words, feedback-control.

The above-mentioned patent, however, fails to recite how the gain can be tuned while the motor is being driven. Further, the gain cannot be suitably tuned in a case where a load is variable over time.

### SUMMARY OF THE INVENTION

The present invention was implemented in order to solve the foregoing problems, and a main object thereof is to provide an image formation apparatus capable of improving an image quality by adjusting (tuning) a gain to an optimal value.

An image formation apparatus according to an aspect of the present invention is provided with a direct-current brushless motor, a motor driver circuit which supplies current to the direct-current brushless motor based on an instruction signal in accordance with a targeted speed in order to drive the direct-current brushless motor, and a control circuit which adjusts the instruction signal outputted as a result of a proportional-integral-derivative operation control processing so that the motor driver circuit follows the targeted speed in response to input of a rotation signal outputted from the motor driver circuit. The control circuit detects a targeted error based on comparison between a reference pulse signal indicating the targeted speed and a rotation pulse signal functioning as the rotation signal, and adjusts a gain used in the proportional-integral-derivative operation control processing based on the detected error.

The control circuit preferably adjusts the gain using a predetermined linear function changeable depending on the targeted speed.

The control circuit preferably determines whether or not the targeted error stays within a predetermined range, and adjusts the gain based on a result of the determination.

In particular, the control circuit decreases a value of the gain in a case where the targeted error stays within the predetermined range, and increases the value of the gain in a case where the targeted error fails to stay within the predetermined range.

In particular, the value of the gain is set to stay in a range between a smallest value of the gain and a largest value of the gain.

The control circuit preferably adjusts the gain based on a plurality of gain values previously set in accordance with the targeted speed.

An image formation apparatus according to another aspect of the present invention is provided with a direct-current brushless motor, a motor driver circuit which supplies current to the direct-current brushless motor based on an instruction signal in accordance with a targeted speed in order to drive the direct-current brushless motor, and a control circuit which adjusts the instruction signal outputted as a result of a proportional-integral-derivative operation control processing so that the motor driver circuit follows the targeted speed in response to input of a rotation signal outputted from the motor driver circuit, wherein the control circuit adjusts a gain used in the proportional-integral-derivative operation control processing in accordance with a drive sequence.

The image formation apparatus detects the targeted error based on the comparison between the reference pulse signal indicating the targeted speed and the rotation pulse signal functioning as the rotation signal, and tunes the gain used in the proportional-integral-derivative operation control processing to show a suitable value based on the detected error while the motor is being driven in order to adjust the gain used in the proportional-integral-derivative operation control processing. As a result, the image quality is improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic sectional view illustrating a schematic hardware constitution of a copying machine 1 according to the present example of the present invention to which an image formation apparatus according to the present invention is applied.

FIG. 2 is an illustration of a constitution wherein the drive of a DC brushless motor is controlled by a CPU in a controller.

FIG. 3 is an illustration of a block diagram of a servo mechanism according to the present example.

FIG. 4 is a block diagram illustrating the inside of a motor block.

FIG. 5 is an illustration of a gain adjusted in accordance with a rotation speed (number of rotations) according to the example of the present invention.

FIG. 6 is a flow chart illustrating a gain adjustment method according to the example of the present invention.

FIG. 7 is an illustration of a block diagram of a servo mechanism according to a modification of the example of the present invention.

FIG. 8 is a flow chart illustrating a gain adjustment method according to the modification of the example of the present invention.

FIG. 9 is an illustration of a constitution of a conventional DC brushless motor.

FIG. 10 is an illustration of a constitution in a motor control substrate.

FIG. 11 is an illustration of gain tuning in accordance with number of rotations.

### DESCRIPTION OF THE PREFERRED EXAMPLES

Hereinafter, an example of the present invention is described referring to the drawings. In the description below, the same components are provided with the same reference symbols, and those components are called likewise and function in the same manner.

Described in the present example is application of an image formation apparatus according to the present invention to a digital color copying machine of the tandem system (hereinafter, referred to as a copying machine). However, the present invention is not necessarily limited to the copying machine, and may be applied to a printer, a facsimile device or an MFP (Multi Function Peripheral) in which functions of the facsimile device and the printer are combined as far as it is an image formation apparatus wherein a DC brushless motor is used in a drive mechanism. Further, a printing method is not necessarily limited to the tandem system or the digital system, and the copying machine may not be the color copying machine and may be a black-and-white copying machine.

The color image formation apparatus of the tandem system is provided with image generators of four colors each including a developer are provided in parallel along an intermediate transfer belt which is an intermediate transfer member, wherein toner images of the respective colors formed in the respective image formation units are transferred onto the intermediate transfer belt (primary transfer), and the respective color toners are overlapped with one another so that a multicolor image is formed. Further, the image resulting from the color toners overlapped with one another on the intermediate transfer belt is transferred to a piece of paper which is a printing medium (secondary transfer) and subjected to a fixing process, and then outputted.

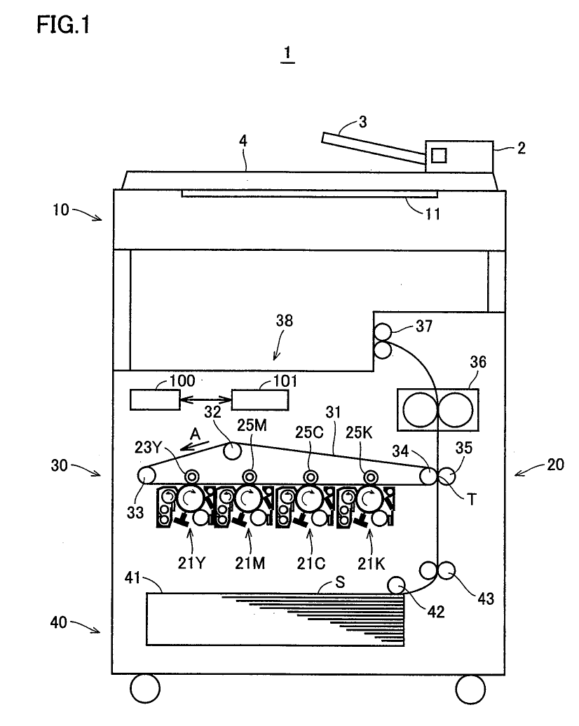

Referring to FIG. 1, a schematic sectional view illustrating a schematic hardware constitution of a copying machine 1 according to the present example, to which the image formation apparatus according to the present invention is applied, is described. Copying machine 1 is a digital color copying machine of the tandem system, wherein four color toners, yellow (Y), magenta (M), cyan (C) and black (K), are overlapped with one another so that a color image is formed.

Referring to FIG. 1, copying machine 1 according to the present example includes an image reading unit 10, a paper transportation unit 20, an image formation unit 30 and a paper storage unit 40.

Image reading unit 10 includes a loading table 3 where documents are set, a document table glass 11, a transporter 2 which automatically transports each of the documents set on loading table 3 to document table glass 11, and a discharge table 4 where the read document is discharged. Further, image reading unit 10 further includes a scanner not shown. The scanner is moved by a scan motor in parallel with document table glass 11. The scanner includes an exposure lamp which illuminates the document, a reflection mirror which changes the direction of a reflection light form the document, a mirror which changes a light path from the reflection mirror, a lens which converges the reflection light, a three-row (R, G and B) photoelectric conversion element which generates an electrical signal in accordance with the received reflection light such as CCD (charge coupled device).

The document transported by transporter 2 is set on document table glass 11 and exposed, and scanned when the scanner moves in parallel with document table glass 11. The reflection light from the document is converted into the electrical signal by the photoelectric conversion element and inputted to image formation unit 30.

Image formation unit 30 is provided with a plurality of rollers 32, 33 and 34 hauling one another so as to avoid any slack therein, and these rollers are rotated anticlockwise in FIG. 1 (direction of arrow A in FIG. 1). Image formation unit 30 includes an intermediate transfer belt 31 which is a continuous belt with no end rotating in a same direction at a predetermined speed, image generators 21Y, 21M, 21C and 21K (which are collectively called image generators 21) corresponding to the toners of the respective colors, yellow (Y), magenta (M), cyan (C) and black (K) spaced at predetermined intervals along intermediate transfer belt 31, a developer included in each of image generators 21, transfer rollers 25Y, 25M, 25C and 25K (which are collectively called transfer rollers 25) each forming a pair with a photosensitive member with intermediate transfer belt 31 interposed therebetween, a fixer 36 which fixes the toner image which was transferred to intermediate transfer belt 31 and then transferred to the paper, a controller 100 including a CPU (Central Processing Unit) and the like though not shown, and a memory 101 which memorizes a program executed by controller 100.

Paper storage unit 40 includes a paper feeding cassette 41 in which paper S, which is a printing medium, is housed. Paper transportation unit 20 includes rollers 42, 43, 35 and 37 for transporting the paper S from paper feeding cassette 41 and a paper discharge tray 38 which discharges the paper on which the image is printed.

Controller 100 reads the program from memory 101 based on an instruction signal inputted from an operation panel or the like, not shown, and executes the read program to thereby control the respective components. Further, controller 100 may be provided with a time counting device such as a timer therein so that the program is executed when a predetermined time amount is counted. Controller 100 and memory 101 may be provided in image reading unit 10 or paper transportation unit 20 other than image formation unit 30.

Controller 100 executes the program to thereby execute a predetermined image processing to an image signal inputted from image reading unit 10 or an external device, and generate a digital signal converted into each of the colors, yellow, magenta, cyan and black. Image color data for cyan, image color data for magenta, image color data for yellow, and image color data for black generated by controller 100 in order to form the image are respectively outputted from controller 100 to exposure portions provided in image generators 21 depending on the colors.

The exposure portion outputs laser beam to the photosensitive member based on the image data inputted from controller 100 so that a surface of the photosensitive member evenly electrostatically charged is exposed depending on the image data, and an electrostatic latent image is thereby formed. A developing bias voltage is applied to a developing roller, and a potential difference in comparison to a latent image potential of the photosensitive member is thereby generated. When the charged toner is supplied in this state, the toner image is formed on the surface of the photosensitive member. The toner image formed on the surface of the photosensitive member is transferred to intermediate transfer belt 31, which is an image carrier, by transfer rollers 25 having a constant voltage or constant current. This is called the primary transfer.

The toner image primarily transferred onto intermediate transfer belt 31 is transferred onto the paper S transported from paper feeding cassette 41 by roller 34. This called the secondary transfer. The toner image secondarily transferred onto the paper is fixed on the paper by fixer 36 and discharged into paper discharge tray 3 as an electronic photograph image.

In copying machine 1 thus constituted, a DC brushless motor can be used in a drive mechanism, for example, a mechanism for driving the photosensitive members and the various rollers in image generators 21, a mechanism for driving fixer 36, or a mechanism for driving rollers 42, 43, 35 and 37 of paper transportation unit 20. In the present invention, it is not limited in which of the drive mechanisms the DC brushless motor is used, and the DC brushless motor can be used in any of them. The DC brushless motor may be used in a mechanism not mentioned above.

In copying machine 1 according to the present example, the drive of the DC brushless motor is controlled by CPU 200 in controller 100.

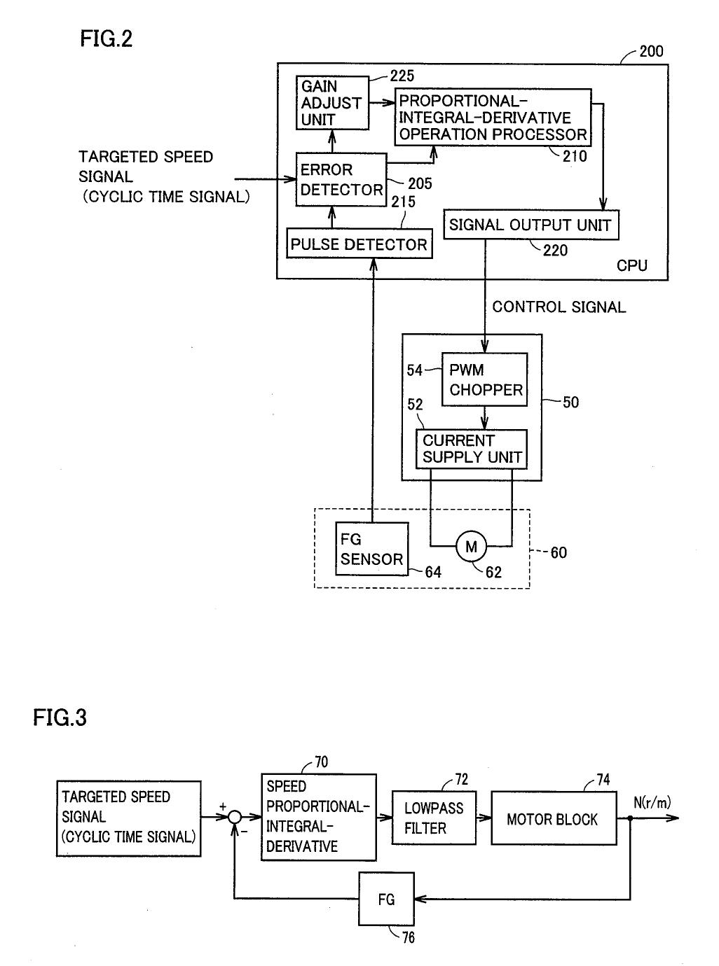

Referring to FIG. 2, a constitution wherein the drive of the DC brushless motor is controlled by CPU 200 in controller 100 is described.

As shown in FIG. 2, functions shown in CPU 200 are mainly formed in CPU 200 when CPU 200 reads the program from memory 101 and executes it. However, at least a part of them may be realized in the hardware configuration shown in FIG. 1.

A motor unit 60 controlled by CPU 200 and a motor driver circuit 50 which drives a motor (DC brushless motor) 62 of motor unit 60 are illustrated as the hardware configuration.

Motor unit 60 includes motor 62 and an FG sensor 64 which generates an FG pulse, which is a rotation signal, based on the change of magnetic flux in accordance with a rotation speed of a rotor of motor 62.

Motor driver circuit 50 includes a PWM chopper 54 which generates a PWM (Pulse Width Modulation) signal in response to input of a control signal from CPU 200, and a current supply unit 52 which adjusts current supplied to motor 62 in accordance with the PWM signal of PWM chopper 54.

CPU 200 includes a pulse detector 215 which detects the FG pulse from FG sensor 64, an error detector 205 which detects an error value by comparing a targeted speed signal (cyclic time signal) inputted from outside to the FG pulse detected by pulse detector 215, a proportional-integral-derivative operation processor 210 which executes an operation processing to an proportional term P, an integral term I and a differential term D in accordance with the inputted error value, a gain adjust unit 225 which adjusts a gain when the proportional-integral-derivative operation processing is executed based on the error value, and a signal output unit 220 which generates a signal for outputting a result of the proportional-integral-derivative operation processing to the motor driver circuit.

Though not shown in the drawing, a clock signal may be generated by an oscillation circuit, or the like, provided in controller 100, and the cyclic time signal, which is the targeted speed signal, may be generated based on the clock signal and inputted to CPU 200. The cyclic time signal, which is the targeted speed signal, can be generated inside CPU 200 or inputted from outside of controller 100. Any information necessary for the generation of the cyclic time signal, which is the targeted speed signal, may be stored in memory 101.

Referring to FIG. 3, described below is a block diagram of a servo mechanism according to the example of the present invention.

As shown in FIG. 3, a feedback control system constitutes the servo mechanism. More specifically, the cyclic time signal indicating a counting period of the clock signal inside the CPU and corresponding to the targeted speed signal is inputted, and a speed deviation (error) is calculated based on a count number obtained when a period from the fall to the rise of the current FG pulse of the motor is counted by the clock inside the CPU. Then, the speed deviation (error) is given to a speed proportional-integral-derivative block 70.

Then, a processing result of the proportional-integral-derivative operation processing is sent from speed proportional-integral-derivative block 70 to a motor block 74 via a lowpass filter 72 included in signal output unit 220, which is a digital filter, as a motor output instruction. Lowpass filter 72 is provided as a noise removing device. An FIR (Finite Impulse Response) filter, an IIR (Infinite Impulse Response) filter or a notch filter constitutes the digital filter.

The rotation speed (N (rprn)) is outputted from motor block 74, and the rotation speed from motor block 74 is converted into the FG pulse by an FG block 76 as a feedback processing. Then, the speed deviation between the targeted speed signal and the FG pulse indicating the actual speed is calculated based on the count number obtained when the period from the fall to the rise of the current FG pulse of the motor is counted by the clock inside the CPU.

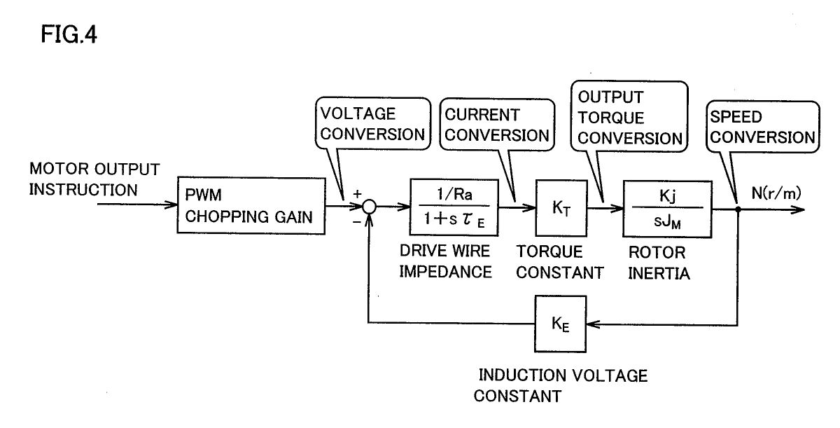

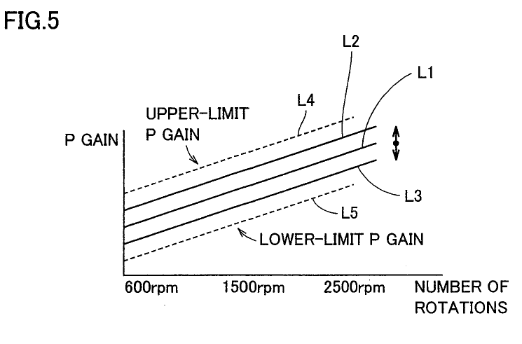

Referring to FIG. 4, a block diagram illustrating the inside of motor block 74 is described.

As shown in FIG. 4, the motor output instruction inputted via lowpass filter 72 is converted into a voltage value by a PWM chopping gain.

A difference between a feedback voltage calculated by an induction voltage coefficient K_{E} and the voltage value converted by the PWM chopping gain is calculated. Then, the conversion into current is implemented by a drive wire impedance (1/Ra)/(1+sτ_{E}) based on the voltage difference value, and the conversion into an output torque is implemented in accordance with the converted current value and a toque constant K_{T}. The output torque is converted into the rotation speed by the inertia of a rotor (kj/sT_{M}). The converted rotation speed is converted into the feedback voltage by the induction voltage coefficient K_{E} as described earlier.

Referring to FIG. 5, the gain adjustment in accordance with the rotation speed (number of rotations) according to the example of the present invention is described.

As shown in FIG. 5, the adjustment of P gain, which is the proportional term of the proportional-integral-derivative control, in accordance with the number of rotations is described as an example.

More specifically, it is assumed that linear functions which define an upper-limit P gain and a lower-limit P gain variable depending on the number of rotations are set.

As an example, the upper-limit P gain follows a linear function L4, and the lower-limit P gain follows a linear function L5. The upper-limit P gain or the lower-limit P gain is set to stay within such a range that prevents the gain from being excessively large or excessively small in accordance with the number of rotations.

Further, the P gain is set in accordance with the linear function L1 at the time of initialization or in a normal operation.

The linear function can be set such that the variation of a smallest number of rotations (for example, 600 rpm) and the variation of a largest number of rotations (for example, 2,500 rpm) are monitored, and the optimal P gains of the smallest number of rotations and the largest number of rotations are respectively calculated so that the linear function L1 is defined based on the respective P gains.

As an example, linear functions L2 to L5, which are obtained when the linear function L1 as a reference is increased or decreased by a predetermined amount, can be defined based on the linear function L1.

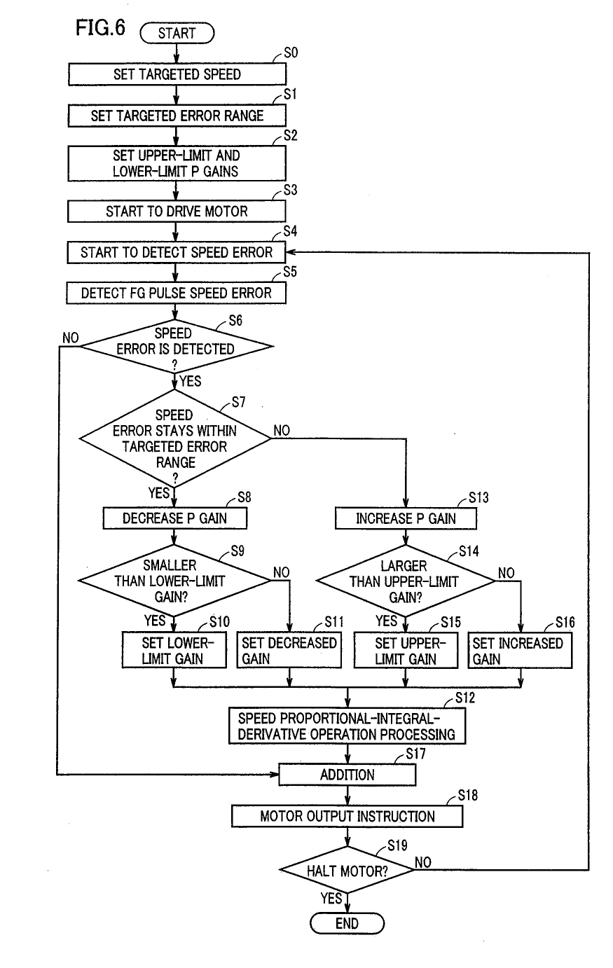

Referring to FIG. 6, described is a method for adjusting the gain according to the example of the present invention.

As shown in FIG. 6, the targeted speed is set (Step S0). More specifically, the targeted speed signal (cyclic time signal) is inputted.

Next, set is a targeted error range which appears to be an error range in which the speed of the motor follows the targeted speed (Step S1). The range can be set to a predetermined range, or can be flexibly adjusted in accordance with the targeted speed (number of rotations). The range is stored in, for example, memory 101.

Then, the upper-limit and lower-limit P gains are set (Step S2). It is assumed that the upper-limit P gain and the lower-limit P gain are calculated depending on the targeted speed (number of rotations) by means of the linear functions L4 and L5 in accordance with FIG. 4 as described earlier.

Then, the drive of the motor starts (Step S3). When it starts, the control signal is outputted from CPU 200 so that the targeted speed (number of rotations) is obtained. For example, a table, or the like, in which the targeted speeds and the levels of the control signal corresponding thereto are shown, may be memorized in memory 101, and the level of the control signal corresponding to the inputted targeted speed signal can be set referring to the table.

The detection of the speed error then starts (Step S4), and the speed error of the FG pulse (speed deviation) is detected (Step S5). More specifically, the FG pulse detected by pulse detector 215 is outputted to error detector 205, and the cyclic time signal corresponding to the counting period of the clock signal in the CPU is inputted to error detector 205. Then, the speed error is calculated based on a counter number difference in comparison to the count number obtained when the period from the fall to the rise of the current FG pulse of the motor is counted by the clock inside the CPU.

Then, it is determined whether or not there is any speed error by error detector 205 (Step S6). As a possible method for determining the speed error, an error margin to a certain extent in comparison to the targeted speed is taken into account, and the speed error can be determined in a case where the error beyond the error margin occurs.

In a case where it is determined in Step S6 that the speed error is generated, error detector 205 further determines whether or not the speed error stays within the targeted error range (Step S7).

In a case where it is determined in Step S7 that the speed error stays within the targeted error range (Y in Step S7), the P gain is decreased (Step S8). More specifically, in a case where it is determined that the speed error stays within the targeted error range, it is more appropriate to decrease the error value and lessen a signal variation amount by decreasing the P gain so that the speed is quickly adjusted to follow the targeted speed than to amplify the error value and thereby increasing the signal variation amount by increasing the P gain. In brief, error detector 205 sends an instruction for adjusting the P gain by a predetermined amount to gain adjust unit 225.

Then, it is determined whether or not the adjusted value is smaller than the lower-limit gain (Step S9). More specifically, gain adjust unit 225 determines whether or not the adjusted value is smaller than the lower-limit gain in a case where the predetermined amount is subtracted from the P gain value currently set based on the instruction for adjusting the gain from error detector 205 (instruction for decreasing the P gain).

In a case where it is determined that the adjusted value is smaller than the lower-limit gain, gain adjust unit 225 sets the gain value of the proportional-integral-derivative operation processor 210 to the lower-limit gain (Step S10).

The lower-limit gain is thus set because the gain will be excessively small when the lower-limit gain is set to be lower than the set value, which makes it not possible to maintain the targeted speed in a case where disturbance, or the like, is inputted.

Then, the speed proportional-integral-derivative operation processing is executed based on the set gain (Step S12).

In a case where it is determined in Step S9 that the adjusted value is at least the lower-limit gain, gain adjust unit 225 sets the gain obtained when the predetermined amount is subtracted from the current gain value (Step S11), and the speed proportional-integral-derivative operation processing is executed based on the set gain (Step S12).

In a case where the speed error fails to stay within the targeted error range (N in Step S7), the P gain is increased (Step S13). More specifically, when it is determined that the speed error is beyond the targeted error range, the p gain is increased so that the error value, which is still excessively large, is amplified so that the signal variation amount is increased. In brief, error detector 205 sends an instruction for adjusting the P gain by a predetermined amount to gain adjust unit 225.

Further, it is determined whether or not the adjusted value is larger than the upper-limit gain (Step S14). More specifically, gain adjust unit 225 determines whether or not the adjusted value is larger than the upper-limit gain in a case where the P gain is increased by the predetermined amount from the P gain value currently set based on the instruction for adjusting the P gain (instruction for increasing the P gain) from error detector 205.

In a case where it is determined that the adjusted value is larger than the upper-limit gain, the value is set to the upper-limit gain (Step S15). The upper-limit gain is set to prevent the deterioration of an image quality or the generation of too a large noise when the image formation apparatus is driven because the gain is excessively large when the gain is set to be larger than the set upper-limit value.

Then, the speed proportional-integral-derivative operation processing is executed based on the set gain (Step S12).

In a case where it is determined that the adjusted value is at most the upper-limit gain in Step S14, gain adjust unit 225 sets the gain obtained when the current gain value is increased by the predetermined amount (Step S16). Then, the speed proportional-integral-derivative operation processing is executed based on the set gain (Step S12).

Then, a result of the current speed proportional-integral-derivative operation processing and a result of the last speed proportional-integral-derivative operation processing are added to each other (Step S17). An instruction for outputting the control signal is outputted to motor driver circuit from signal output unit 220 based on a result of the addition obtained by proportional-integral-derivative operation processor 210 (Step S18).

In a case where it is determined in Step S6 that there is no speed error by error detector 205, the processing advances to Step S17. In this case, there is no speed error, meaning that there is no error operation result. Therefore, “0” is added to the last speed proportional-integral-derivative operation processing result. Thus, the same result as that of the last addition is outputted.

Then, the instruction for outputting the control signal is outputted to the motor driver circuit based on the addition result.

It is determined whether or not an instruction for halting the motor is inputted (Step S19), and Steps S4 to S19 are repeated until the instruction for halting the motor is inputted.

In a case where the instruction for halting the motor is inputted, the processing is terminated (Step S20). As an example of the instruction for halting the motor, it can be determined that the instruction for halting the motor is inputted when input of the targeted speed signal is halted. However, the instruction for halting the motor does not necessarily depend on input of the targeted speed signal, and any method can be adopted as far as the instruction for halting the motor can be confirmed.

According to the gain adjustment method provided by the example of the present invention, the gain used in the proportional-integral-derivative operation processing can be tuned to any appropriate value during the drive.

Therefore, the image quality can be improved because any irregularity in the rotation due to the gain which is excessively large or excessively small can be prevented from deteriorating, and the gain is optimally tuned.

Further, in a case where a load is variable over time, the gain is increased when the load is largely variable and decreased when the variation of the load is small so that the gain is suitably tuned. As a result, the speed can be controlled in a stable manner.

Further, the gain can be suitably tuned against input of the disturbance. As a result, the servo control resistant to the disturbance can be realized.

In the description of FIG. 5, the P gain is adjusted in accordance with the number of rotations, however, the P gain can be adjusted in accordance with not only the number of rotations but also a drive sequence.

For example, the P gain can be set to be high in accordance with the linear function L2 during the formation of the image so that the variation of the rotation due to any unexpected variation of the load is controlled and the image quality is improved, and the P gain can be set to be low in accordance with the linear function L3 after the image formation so that the noise is decreased.

Not only the gain of the proportional term P but also the gains of the integral term I and the differential term D can be similarly adjusted. More specifically, the gains of the proportional term P, integral term I and differential term D are correlated to one another. For example, a ratio among the gains of the proportional term P, integral term I and differential term D may be previously set so that the gains of the integral term I and the differential term D are also adjusted when the gain of the proportional term P is adjusted.

### Modification to the Example

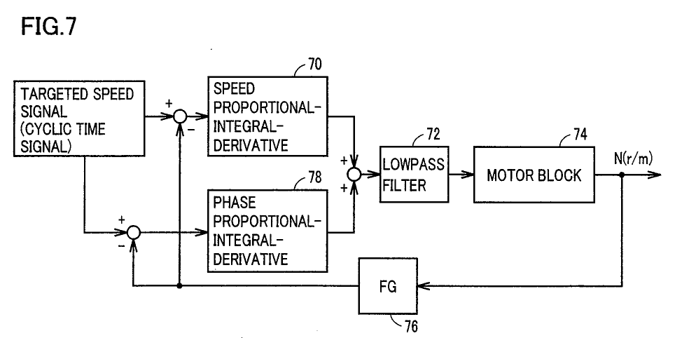

Referring to FIG. 7, described is a block diagram of a servo mechanism according to a modification of the example of the present invention.

As shown in FIG. 7, the feedback control system constitutes the servo mechanism. More specifically, the speed deviation in comparison to the current FG pulse of the motor is given to the speed proportional-integral-derivative block, and a phase deviation in comparison to the current FG pulse of the motor is given to a phase proportional-integral-derivative block 78.

A result of the proportional-integral-derivative operation processing obtained from speed proportional-integral-derivative block 70 and a result of the proportional-integral-derivative operation processing obtained from phase proportional-integral-derivative block 78 are added to each other and given to motor block 74 via lowpass filter 72 which is a digital filter.

A speed signal (N (r/m)) is outputted from motor block 74, and the speed of motor block 74 is converted into the FG pulse by FG block 76 so that the deviation (error) based on the targeted speed signal is calculated.

The constitution according to the modification of the example of the present invention is thus further provided with phase proportional-integral-derivative block 78. In a case where phase proportional-integral-derivative block 78 is thus provided, the addition of the phase deviation can also be implemented. As a result, the servo control with a high accuracy can be realized.

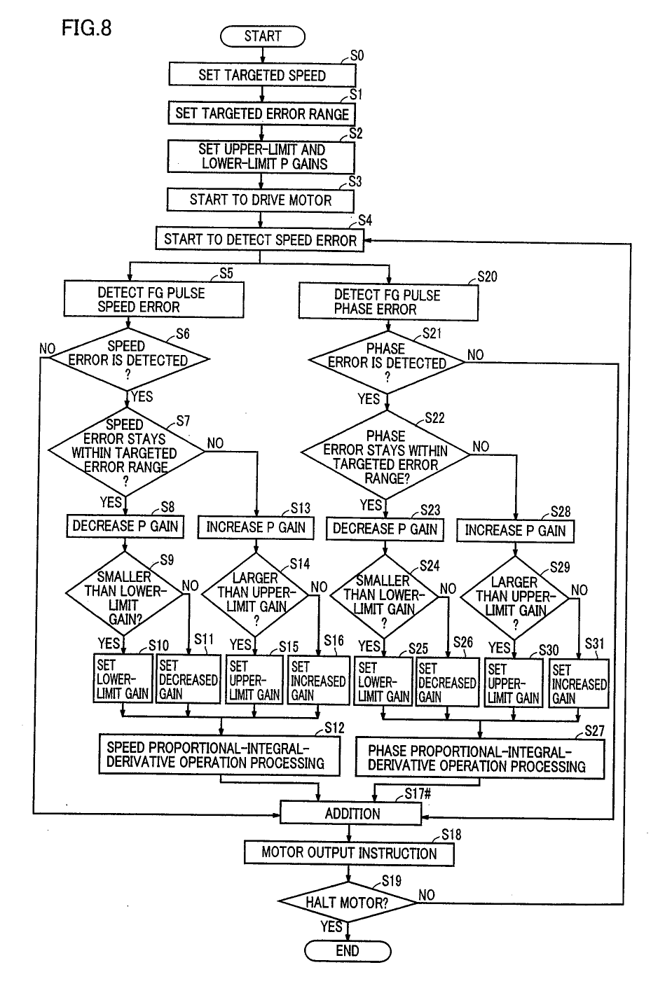

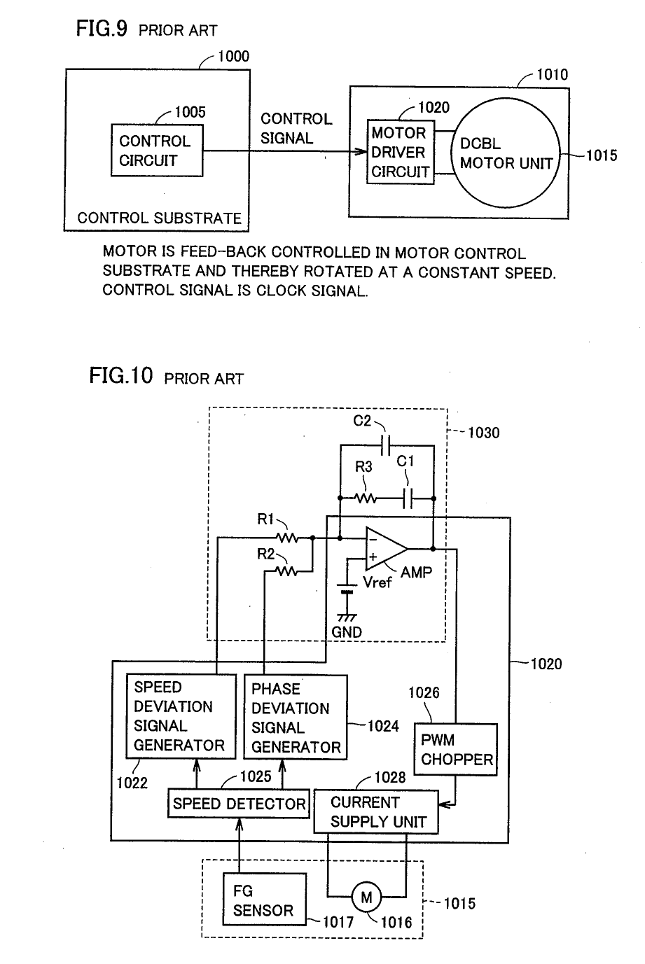

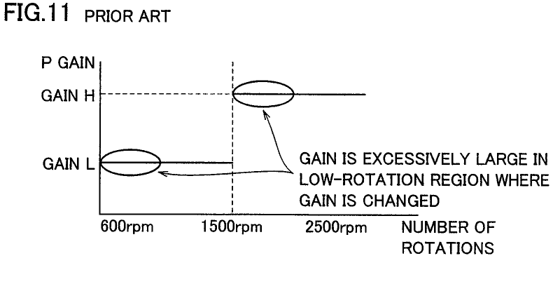

Referring to FIG. 8, described is a method for adjusting the gain according to the modification of the example of the present invention.

As shown in FIG. 8, a difference in comparison to the flow shown in FIG. 6 is that Steps S20 to S27 are further provided, and Step S17 is replaced with Step S17#.

More specifically, after the detection of the speed error starts (Step S4), a phase error of the FG pulse is detected (Step S20). The FG pulse detected by pulse detector 215 is outputted to error detector 205, and the phase error of the FG pulse relative to the targeted speed signal is detected by error detector 205.

Next, it is determined whether or not there is any phase error (Step S21). As a possible method for determining the phase error, an error margin to a certain extent in comparison to a targeted value is taken into account, and the phase error can be determined in a case where the error beyond the error margin occurs.

In a case where it is determined in Step S21 that there is the phase error, error detector 205 determines whether or not the error stays within a targeted error range (Step S22).

In a case where it is determined in Step S22 that the error stays within the targeted error range (Y in Step S22), the P gain is decreased in a manner similar to the description earlier (Step S23). More specifically, in a case where it is determined that the error stays within the targeted error range, it is more appropriate to decrease the error value and lessen the signal variation amount by decreasing the P gain so that the speed is quickly adjusted to follow the targeted speed than to amplify the error value and thereby increasing the signal variation amount by increasing the P gain.

Next, it is determined whether or not the adjusted value is smaller than the lower-limit gain (Step S24).

Gain adjust unit 225 sets the lower-limit gain in a case where it is determined that the adjusted value is smaller than the lower-limit gain (Step S25).

Then, the phase proportional-integral-derivative operation processing is executed based on the set gain (Step S27).

In a case where it is determined in Step S24 that the adjusted value is at least the lower-limit gain in Step S24, the decreased gain is set (Step S26). Then, the phase proportional-integral-derivative operation processing is executed based on the set gain (Step S27).

In a case where it is determined that the error fails to stay within the targeted error range in Step S22 (N in Step S22), the P gain is increased (Step S28).

More specifically, in a case where it is determined that the error fails to stay within the targeted error range, the P gain is increased so that the error value, which is still excessively large, is amplified, and the signal variation amount is increased.

Then, it is determined whether or not the adjusted value is larger than the upper-limit gain (Step S29).

In a case where it is determined that the adjusted value is larger than the upper-limit gain, the value is set to the upper-limit gain (Step S30).

Then, the phase proportional-integral-derivative operation processing is executed based on the set gain (Step S27).

In a case where the adjusted value is not larger than the upper-limit gain in Step S29, the increased value is set (Step S31). Then, the phase proportional-integral-derivative operation processing is executed based on the increased gain (Step S27).

A result of the phase proportional-integral-derivative operation processing and a result of the speed proportional-integral-derivative operation processing are added to each other (Step S17#). In a case where there is no speed error, the result of the last speed proportional-integral-derivative operation processing is used. In a case where there is no phase error, the result of the last phase proportional-integral-derivative operation processing is used.

Then, the instruction for outputting the control signal is outputted to the motor driver circuit from signal output unit 220 based on a result of the addition obtained by proportional-integral-derivative operation processor 210 (Step S18).

In a case where it is determined in Step S21 that there is no phase error, the processing advances to Step S17#. In this case, the processing advances to the addition based on the recognition that the operation result shows “0” because there is no phase error.

Accordingly, the instruction for outputting the control signal is outputted to the motor driver circuit based on another addition result.

Then, it is determined whether or not the instruction for halting the motor is inputted as described earlier (Step S19). The processing advances to Step S4 in a case where the instruction for halting the motor is not inputted, and the foregoing steps are repeated until the motor is halted.

In a case where the instruction for halting the motor is inputted, the processing is terminated (Step S20).

The constitution according to the modification of the example of the present invention is thus further provided with phase proportional-integral-derivative block 78 so that the addition of the phase deviation is further executed. As a result, the servo control can achieve a higher accuracy.

Further, the gain is thus tuned to show a suitable value during the drive in relation to the phase proportional-integral-derivative block, and the speed can be more speedily controlled by such an optimal gain tuning.

The P gain of the proportional term in the phase proportional-integral-derivative block and the P gain of the proportional term in the speed proportional-integral-derivative block are not necessarily equal to each other, and can be respectively set to suitable values in accordance with the respective error characteristics. In the description of FIG. 5, the P gain is adjusted in the speed proportional-integral-derivative block. However, the P gain adjusted in the phase proportional-integral-derivative block can be separately provided.

In the description of the present modification, the P gain is adjusted by means of the linear function. However, the method of the adjustment is not necessarily limited to the linear function, and another method may be adopted so that the P gain is adjusted. For example, a plurality of P gains for the adjustment can be provided in relation to the P gain corresponding to the necessary number of rotations for the gain tuning. The gain can be tuned referring to a table, not shown, in which a plurality of P gains for the adjustment corresponding to the necessary number of rotations are stored.

A computer can be used as a controller which controls the image formation apparatus so that a program which executes the control processing described so far is provided. The program can be provided as a program product which is recorded on a computer-readable recording medium such as a flexible disc attached to the computer, a CD-ROM (Compact Disk-Read Only Memory), a ROM (Read Only Memory), a RAM (Random Access Memory) or a memory card. The program can be recorded on a recording medium incorporated in the computer such as a hard disc or downloaded via network and then provided.

The program may be configured to execute a processing by calling a necessary module of program modules provided as a part of an operation system (OS) of the computer in a predetermined sequence by a predetermined timing. In that case, the module is not included in the program itself, and the processing is executed in cooperation with the OS. Such a program not including the module can be included as the program according to the present invention.

The program may be incorporated into a part of another program and provided. In that case, the module included in another program is not included in the program itself, and the processing is executed in cooperation with the OS. Such a program incorporated in another program can be included as the program according to the present invention.

The program product to be provided is installed in a program storage unit such as a hard disc and then executed. The program product includes the program itself and the recording medium on which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image formation apparatus comprising:
a direct-current brushless motor;
a motor driver circuit which supplies current to said direct-current brushless motor based on an instruction signal in accordance with a targeted speed in order to drive said direct-current brushless motor; and
a control circuit which adjusts said instruction signal outputted as a result of a proportional-integral-derivative operation control processing so that said motor driver circuit follows said targeted speed in response to input of a rotation signal outputted from said motor driver circuit, wherein
said control circuit detects a targeted error based on comparison between a reference pulse signal indicating said targeted speed and a rotation pulse signal functioning as said rotation signal, and adjusts a gain used in said proportional-integral-derivative operation control processing based on the detected error.

2. The image formation apparatus according to claim 1, wherein
said control circuit adjusts said gain using a predetermined linear function changeable depending on said targeted speed.

3. The image formation apparatus according to claim 1, wherein
said control circuit determines whether or not said targeted error stays within a predetermined range, and adjusts said gain based on a result of the determination.

4. The image formation apparatus according to claim 3, wherein
said control circuit decreases a value of said gain in a case where said targeted error stays within the predetermined range, and increases the value of said gain in a case where said targeted error fails to stay within the predetermined range.

5. The image formation apparatus according to claim 4, wherein
the value of said gain is set to stay in a range between a smallest value of the gain and a largest value of the gain.

6. The image formation apparatus according to claim 1, wherein
said control circuit adjusts said gain based on a plurality of gain values previously set in accordance with said targeted speed.

7. An image formation apparatus comprising:
a direct-current brushless motor;
a motor driver circuit which supplies current to said direct-current brushless motor based on an instruction signal in accordance with a targeted speed in order to drive said direct-current brushless motor; and
a control circuit which adjusts said instruction signal outputted as a result of a proportional-integral-derivative operation control processing so that said motor driver circuit follows said targeted speed in response to input of a rotation signal outputted from said motor driver circuit, wherein
said control circuit adjusts a gain used in said proportional-integral-derivative operation control processing in accordance with a drive sequence.
